(19) United States
(12) Patent Application Publication
(10) Pub. No.: US 2012/0134757 A1
(43) Pub. Date: May 31, 2012

(54) MILLING CUTTER

(75) Inventor: HUI-CHENG LI, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 12/978,651

(22) Filed: Dec. 27, 2010

(30) Foreign Application Priority Data
Nov. 26, 2010 (CN) 201010561567.8

(51) Int. Cl. B23C 5/10; B23C 5/02

(52) U.S. Cl. 407/61; 407/114

(57) ABSTRACT

A cutter includes a cutter handle and cutter head including a main body and a plurality of curved cutting edges separately extending from a periphery of the main body. Each cutting edge has a top surface, a first side blade surface, a second side blade surface, and a bottom surface. The top surface, the first side blade surface, the second side blade surface, and the bottom surface intersect to form a front edge, a middle edge, and a back edge. The front edge, the middle edge, and the back edge cooperatively form an edge tip. A tangent of the middle edge at the edge tip intersects with the bottom surface to form a cutting angle in a range from 30° to 60°.

### BACKGROUND

1. Technical Field

The present disclosure relates generally to machining process and, more particularly, to a milling cutter.

2. Description of Related Art

Plastic products often retain excess material after molding, such as sprue. The excess portions are removed from the plastic products by a cutter in a precision machining process. However, in the precision machining process, the cutter is rotated at a high speed, whereby friction heat is generated between the cutter and the plastic products, thereby melting an outer surface of the plastic products. Thus, after the precision machining process is completed, the outer surface of the product may be marred.

Therefore, there is room for improvement within the art.

### BRIEF DESCRIPTION OF THE DRAWINGS

The elements in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a cutter.

FIG. 2 is an enlarged view of a circular part II of FIG. 1.

FIG. 3 is an enlarged, side view of the cutter of FIG. 1.

### DETAILED DESCRIPTION

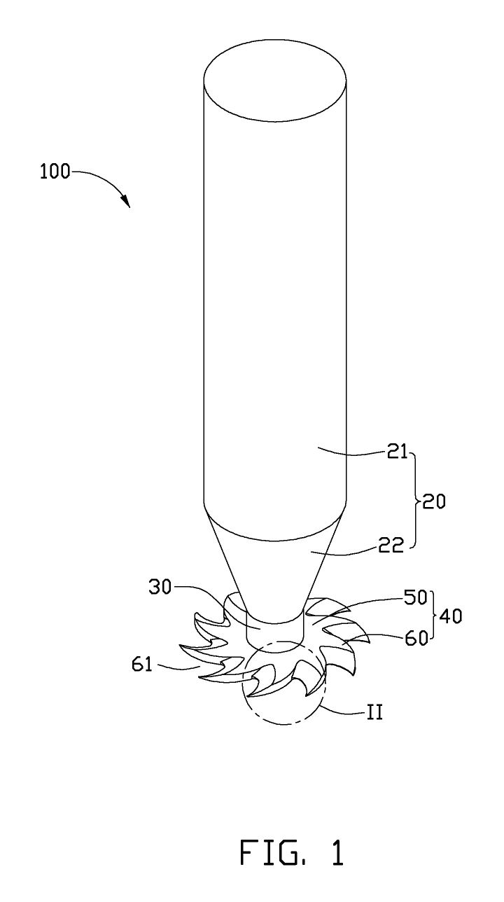

Referring to FIG. 1, an embodiment of a cutter 100 includes a cutter handle 20, a cutter neck 30, and a cutter head 40. The cutter neck 30 interconnects the cutter head 40 to the cutter handle 20. In the illustrated embodiment, the cutter 100 is used for machining a plastic product (not shown) of acrylonitrile butadiene styrene (ABS).

The cutter handle 20 includes a shaft portion 21 and an assembly portion 22 extending from an end of the shaft portion 21. The assembly portion 22 is tapered with a diameter decreasing away from the shaft portion 21. The cutter neck 30 is fixed on an end of the assembly portion 22 away from the shaft portion 21.

The cutter head 40 is fixed on the cutter neck 30. The cutter head 40 includes a main body 50 and a plurality of cutting edges 60 separately extending from a periphery of the main body 50. The cutting edges 60 are evenly arranged, and a chip discharge groove 61 is formed between two adjacent cutting edges 60. In the illustrated embodiment, a width of the chip discharge groove 61 is in a range from about 0.8 millimeters (mm) to about 1.1 mm, with ten cutting edges 60 provided. It should be pointed out that a width of the chip discharge groove 61 can be changed according to the product to be machined, and the cutter head 40 can be designed to have more than two cutting edges 60.

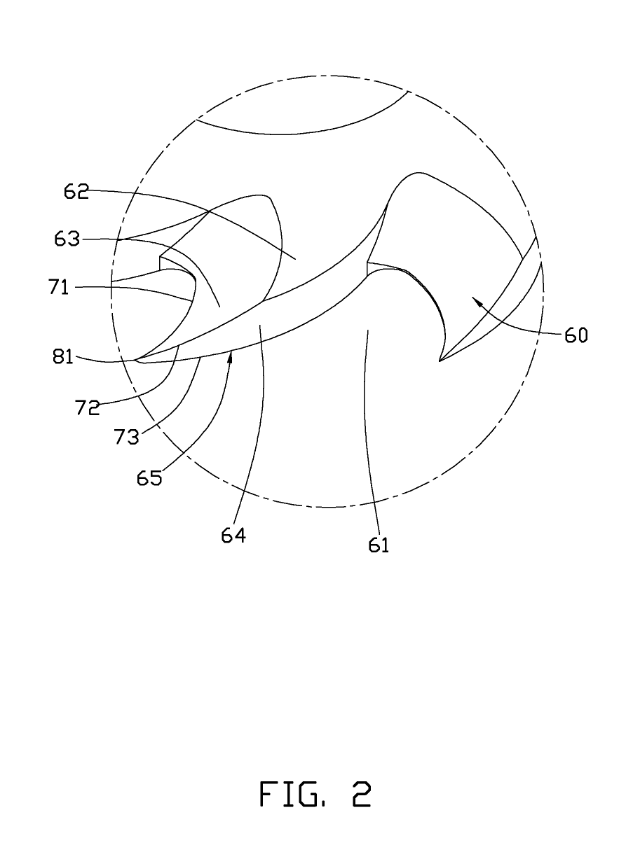

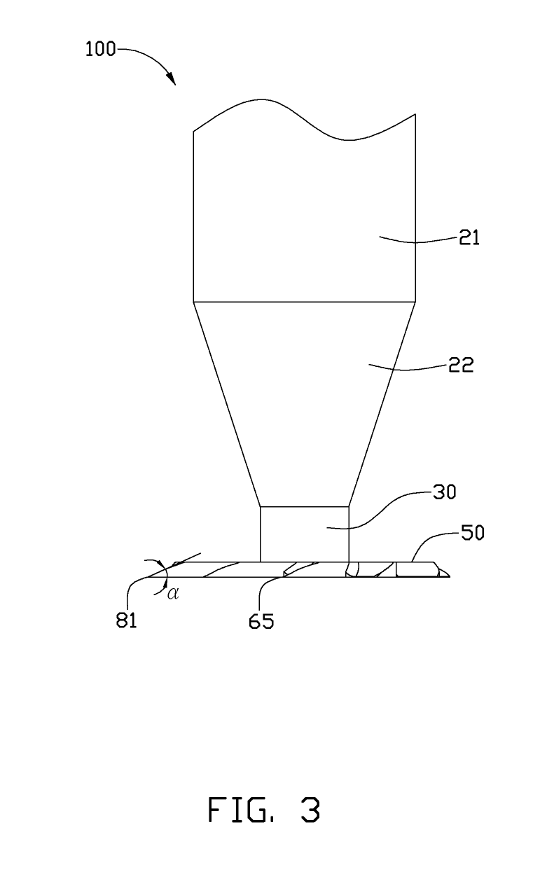

Referring to FIGS. 2 and 3, each cutting edge 60 is curved with a top surface 62, a first side blade surface 63, a second side blade surface 64, and a bottom surface 65. The top surface 62 is adjacent to the cutter neck 30, and the bottom surface 65 is opposite to the top surface 62. The first side blade surface 63 and the second side blade surface 64 connect the top surface 62 to the bottom surface 65. The first side blade surface 63 is a curved surface and intersects with the bottom surface 65 to form a curved front edge 71. The second side blade surface 64 is also a curved surface and intersects with the bottom surface 65 to form a curved back edge 73. The first side blade surface 63 intersects with the second side blade surface 64 to form a curved middle edge 72. The front edge 71, middle edge 72, and the back edge 73 intersect to form an edge tip 81 for cutting. A tangent of the middle edge 72 at the edge tip 81 intersects with the bottom surface 65 to form a cutting angle a (see FIG. 3), from about 30° to about 60°. A front rake angle between the front edge 71 and the bottom surface 65 is in a range from about 5° to about 30°. The cutting angle a and the front rake angle can be changed according to the materials of the plastic product. In the illustrated embodiment, the angle a is about 45°, and the front rake angle is about 8°.

Because the cutting angle a is in a range from about 30° to about 60°, the edge tip 81 has only a small contact area with the plastic product during cutting, generating minimal friction heat between the cutter head 40 and the plastic product, and minimizing the possibility of melting the outer surface of the plastic product. In addition, because the front rake angle is in a range from about 5° to about 30°, the front edges 71 can polish the plastic product after cutting by the edge tips 81. The chips removed from the plastic product can be discharged from the chip discharge grooves 61 of the cutter head 40 in the cutting process.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A cutter, comprising:
a cutter head comprising:
a main body; and
a plurality of cutting edges separately extending from a periphery of the main body, wherein each cutting edge has a top surface, a first side blade surface, a second side blade surface, and a bottom surface; the first side blade surface and the second side blade surface connect the top surface to the bottom surface; the first side blade surface intersects with the bottom surface to form a front edge, the second side blade surface intersects with the bottom surface to form a back edge, the first side blade surface intersects with the second side blade surface to form a middle edge; the front edge, the middle edge, and the back edge intersect to form an edge tip, and a tangent of the middle edge at the edge tip intersects with the bottom surface to form a cutting angle in a range from about 30° to about 60°.

2. The cutter of claim 1, wherein the cutting angle is about 45°.

3. The cutter of claim 1, wherein a front rake angle between the front edge and the bottom surface is in a range from about 5° to about 30°.

4. The cutter of claim 3, wherein the front rake angle is about 8°.

5. The cutter of claim 1, wherein a number of the cutting edges is ten.

6. The cutter of claim 1, wherein the cutting edges are evenly arranged around the main body.

7. The cutter of claim 1, wherein a chip discharge groove is formed between two adjacent cutting edges.

8. The cutter of claim 7, wherein a width of the chip discharge groove is in a range from about 0.8 millimeters to about 1.1 millimeters.

9. The cutter of claim 1, wherein the cutter further comprises a cutter neck on which the cutter head is fixed.

10. The cutter of claim 9, wherein the cutter further comprises a cutter handle comprising a shaft portion and an assembly portion extending from an end of the shaft portion and fixed to the cutter neck.

11. A cutter, comprising:
a cutter handle;
a cutter head; and
a cutter neck connecting the cutter head to the cutter handle;
wherein the cutter head comprises a main body and a plurality of cutting edges separately extending from a periphery of the main body.

12. The cutter of claim 11, wherein the cutting edges are evenly arranged around the main body.

13. The cutter of claim 12, wherein a chip discharge groove is formed between two adjacent cutting edges.

14. The cutter of claim 13, wherein a width of the chip discharge groove is in a range from about 0.8 millimeters to about 1.1 millimeters.
